(19) United States
(12) Patent Application Publication
(10) Pub. No.: US 2024/0309561 A1
(43) Pub. Date: Sep. 19, 2024

(54) Method of Preparing Biodegradable Plant Fiber Masterbatch

(71) Applicant: Liya (Xiamen) New Material Co., Ltd., Xiamen (CN)

(72) Inventors: Haitao CAI, Xiamen (CN); Mei YE, Xiamen (CN); Weilong CAI, Xiamen (CN); Qicong ZHOU, Xiamen (CN); Maorong WU, Xiamen (CN)

(21) Appl. No.: 18/301,212

(22) Filed: Apr. 15, 2023

(30) Foreign Application Priority Data
Mar. 13, 2023 (CN) 202310237455.4

(51) Int. Cl. D01F 6/92; D01F 11/08; D06M 11/38

(52) U.S. Cl. CPC D01F 6/92; D01F 11/08; D06M 11/38; D06M 2101/32

(57) ABSTRACT

A method of preparing biodegradable plant fiber masterbatch includes: step S1, forming a first mixture, a central control device adjusting the quality of calcium oxide added, and selecting the particle size of calcium oxide added; step S2, micronizing the first mixture by microwave grinding via a grinding device, and the central control device adjusts the microwave power; step S3, forming a second mixture, mixing the second mixture, compatibilizer and matrix resin to form a third mixture, and determining the water absorption of the third mixture; step S4, analyzing whether the water absorption of the third mixture meet a preset criteria; step S5, extruding, by a extruding device, the third mixture for granulation, and adjusts the CO₂ concentration in the extruding device.

### FIELD OF THE DISCLOSURE

The invention relates to the technical field of materials, in particular to a method for preparing biodegradable plant fiber masterbatch.

### BACKGROUND OF THE DISCLOSURE

In modern society, with the widespread use of plastic products, the issues of environmental damage and resource waste are becoming increasingly severe. The importance of biodegradable plastics is increasingly highlighted. However, in the current process of preparing biodegradable plastics, although the utilization of plant fibers can make the pellets more environmentally friendly, real-time monitoring and precise regulation based on the characteristics of different plant fibers and specific conditions during the preparation process are lacking, in order to make the prepared pellets both biodegradable and more practical.

Chinese Patent No. CN1288210C discloses a method for manufacturing films, sheets, and utensils using biodegradable pellets as raw materials. The technical features of the pellets consist of the following weight percentage composition: plant fibers (5-75%), carbon dioxide polymer (5-50%), polyvinyl alcohol (5-30%), compatibilizer (1-10%), and plasticizer (1-15%). The above components are thoroughly mixed in a blending machine and then processed into pellets using a plastic granulator, without the capability of monitoring and adjusting the preparation process in real-time.

### SUMMARY OF THE DISCLOSURE

For this reason, the present invention provides a method for preparing biodegradable plant fiber masterbatch, which can address the technical challenges associated with adjusting the relative content of hydrogen bonds in plant fibers, the pH values of various mixtures during the preparation process, the quality of calcium oxide added, microwave power, and carbon dioxide concentration.

Accordingly, the present invention provides a method for preparing biodegradable plant fiber masterbatch. The method includes the following steps.

Step S1, adding calcium oxide into plant fiber to form a first mixture; wherein a central control device is configured to modulate a mass of the calcium oxide based on a relative content of intermolecular hydrogen bonding in the plant fiber, and determine particle size of the calcium oxide based on a proportionate mass of the plant fiber in the first mixture.

Step S2, micronizing the first mixture by microwave grinding using a grinding device; the central control device is configured to acquire a pH value of the first mixture after microwave grinding for a preset duration, and then compare the acquired pH value with a preset pH value for adjusting a microwave power of the grinding device.

Step S3, adding a coupling agent to the first mixture that has been microwave-treated, to achieve co-blending and coating, resulting in the formation of a second mixture; the second mixture, along with a compatibilizer and a matrix resin, are mixed to form a third mixture; the third mixture is then subjected to compounding in a compounding device; the central control device is configured to acquire a mass change of the third mixture after compounding for a second preset duration, and determine a moisture absorption of the third mixture based on the mass change.

Step S4, acquiring, by the central control device, a pH change rate of the third mixture after the second preset duration when the central control device determines that the moisture absorption of the third mixture does not meet a preset criteria; if the pH change rate exceeds the preset criteria, adjusting a temperature and rotational speed of the compounding device; wherein, the central control device acquires a real-time pressure in the compounding device and adjusts an exhaust system of the compounding device when the acquired pressure does not meet the preset criteria, for bring the pressure in the compounding device to meet the preset criteria; if the pH change rate obtained by the central control device is lower than the preset criteria, the mass of calcium oxide in the first mixture is adjusted to ensure that the subsequent biodegradable plant fiber masterbatch meet the preset criteria.

Step S5, when the central control device determines that the moisture absorption of the third mixture meets the preset criteria, extruding, by an extrusion device, the third mixture into pellets, forming biodegradable plant fiber masterbatch; the central control device is configured to acquire a shrinkage of the biodegradable plant fiber masterbatch based on a volume change, and compare the shrinkage with a preset shrinkage criteria; the central control device is further configured to adjust a CO₂ concentration in the extrusion device to ensure that the biodegradable plant fiber masterbatch meet the preset shrinkage criteria.

Furthermore, in Step S1, the central control device is configured to obtain the relative content p of intermolecular hydrogen bonds in the plant fiber, and compare the relative content of hydrogen bonds with the preset relative content P of hydrogen bonds; the central control device then is configured to adjust the mass of the calcium oxide; wherein:
when p≤P1, the central control device determines to decrease the mass of the calcium oxide from m to m1, where m1=m×(1−|P1−p|/P1);
when P1<p<P2, the central control device does not adjust the mass of the calcium oxide;
when p≥P2, the central control device determines to increase the mass of the calcium oxide from m to m2, where m2=m×(1+|P2−p|/P2);
wherein the central control device presets the preset hydrogen bond relative content P; wherein the first preset hydrogen bond relative content is set as P1, and the second preset hydrogen bond relative content P2.

Furthermore, the central control device is configured to acquire a mass proportion d of the plant fiber in the first mixture, wherein d is defined as q1/q, with q being the mass of the first mixture and q1 being the mass of the plant fiber in the first mixture; the central control device is configured to compare the mass proportion with a preset mass proportion D, and determine particle size of the calcium oxide to be added; wherein:
when d≤D1, the central control device determines the calcium oxide with a first preset particle size R1 for addition;
when D1<d<D2, the central control device determines the calcium oxide with the second preset particle size R2 for addition;
when d≥D2, the central control device determines the calcium oxide with the third preset particle size R3 for addition;
wherein the central control device sets the preset mass proportion as D and the preset particle size as R; wherein the first preset mass proportion is D1, the second preset mass proportion is D2; the first, second, and third preset particle sizes are R1, R2, and R3, respectively.

Furthermore, in step S2, the central control device sets a preset pH value K; the central control device is configured to compare a pH value k of the first mixture, which has been micronizing for the first preset duration, with the preset pH value; the central control device then is configured to adjust the microwave power of the grinding device; wherein:
when k≤K, the central control device increases the microwave power of the grinding device;
when k>K, the central control device does not adjust the microwave power of the grinding device.

Furthermore, in step S3, the central control device is configured to acquire a mass change Δg of the third mixture after the second preset duration, and compare the mass change Δg with a preset mass change ΔG to determine the water absorption condition of the third mixture; wherein:
when Δg≤ΔG, the central control device determines that the water absorption condition of the third mixture meets the preset criteria;
when Δg>ΔG, the central control device determines that the water absorption condition of the third mixture does not meet the preset criteria, and obtains the pH change rate of the third mixture.

Furthermore, in step S4, when the central control device determines that the water absorption of the third mixture does not meet the preset criteria, the central control device is configured to obtain the pH change rate Δk of the third mixture, where Δk is set as |k2−k1|, with k1 being the pH value of the third mixture obtained by the central control device at the beginning of the second preset duration, and k2 being the pH value of the third mixture obtained by the central control device at the end of the second preset duration; the central control device is configured to compare the obtained pH change rate with the preset pH change rate ΔK to analyze the reason for the non-compliance of the water absorption of the third mixture with the preset criteria; wherein:
when Δk≤ΔK, the central control device determines that the quality of the calcium oxide in the first mixture does not meet the preset criteria, and increases the mass of the calcium oxide in the first mixture to ensure that the subsequent plant fiber masterbatch meet the preset criteria;
when Δk>ΔK, the central control device determines that the temperature and speed of the mixing device do not meet the preset criteria.

Furthermore, when the central control device obtains the pH change rate of the third mixture that is greater than the preset pH change rate, the central control device is configured to compare the obtained pH change rate of change Δk with a standard value ΔK0 of the preset pH change rate criteria, and adjust the temperature and rotational speed of the compounding device; wherein:
when Δk≤ΔK0, the central control device determines to increase the temperature of the compounding device and increase the rotational speed of the compounding device;
when Δk>ΔK0, the central control device determines to increase the temperature of the compounding device. Δ

Furthermore, when the central control device increases the temperature of the compounding device, the central control device sets a preset pressure value F and compares the real-time pressure value f obtained from the compounding device with the preset pressure value; the central control device determines the activation of the exhaust system and adjusts the opening of an exhaust valve in the exhaust system; wherein:
when f≤F1, the central control device does not activate the exhaust system;
when F1<f<F2, the central control device activates the exhaust system with the opening of the exhaust valve set to a preset value;
when f≥F2, the central control device activates the exhaust system and increases the opening of the exhaust valve from n to n′, where n′=n×(1+|F2−f1/F2/2);
wherein the central control device sets the preset pressure value F and defines the first preset pressure value F1 and the second preset pressure value F2.

Furthermore, the central control device sets a preset criteria value N for the opening of the exhaust valve, and compares the obtained exhaust valve opening with the preset criteria value; the central control device is configured to adjust the number of activated exhaust valves; wherein:
when n′≤N, the central control device does not adjust the number of activated exhaust valves;
when n′>N, the central control device determines to increase the number of activated exhaust valves from z to z1, where

$$z 1 = z \times ( 1 + \sqrt{\frac{\vert N - {n}^{′} \vert}{N}} ) .$$

Furthermore, the central control device obtains the shrinkage degree s of the masterbatch, where s is set as s=s2−s1; where, s1 represents a volume of the masterbatch during extrusion, and s2 represents a volume of the masterbatch after the third preset duration; the central control device compares the obtained shrinkage degree with the preset shrinkage degree S, and adjusts the CO₂ concentration in the extrusion device; wherein:
when s≤S1, the central control device determines to decrease the CO₂ concentration in the extrusion device from w to w1, where

$$w 1 = w \times ( 1 - \sqrt{\frac{s}{S 1}} ) ;$$

when S1<s<S2, the central control device determines not to adjust the CO₂ concentration in the extrusion device;
when s≥S2, the central control device determines to increase the CO₂ concentration in the extrusion device from w to w2, where

$$w 2 = w \times ( 1 + \sqrt{\frac{s}{S 2}} ) ;$$

wherein the central control device sets the preset shrinkage degree S, and defines the first preset shrinkage degree as S1 and the second preset shrinkage degree as S2.

The advantageous effect of this invention, as compared to existing technologies, lies in the incorporation of a central control device. The said central control device regulates the mass of calcium oxide added based on the relative content of hydrogen bonds between plant fiber molecules, and obtains the particle size of calcium oxide based on the proportion of plant fiber quality. The grinding device then subjects the first mixture of plant fiber and calcium oxide to microwave grinding. The central control device adjusts the microwave grinding power of the grinding device based on the pH value of the first mixture after a preset first time. After the microwave grinding, a coupling agent is added to the second mixture to form a composite coating, and a third mixture is formed by blending the composite coating with a compatible agent and a matrix resin. The third mixture is then fed into a compounding device for compounding, and the central control device acquires the water absorption status after a preset second time. In case the water absorption does not meet the preset criteria, the central control device conducts an analysis of the cause and adjusts the temperature and speed of the compounding device accordingly. Furthermore, the real-time pressure in the compounding device obtained by the central control device is compared with the preset pressure, and adjustments are made to the exhaust system. Once the water absorption meets the preset criteria, the extrusion device extrudes the third mixture into pellets to form biodegradable plant fiber granules, and the central control device adjusts the CO₂ concentration in the extrusion device based on the shrinkage of the biodegradable plant fiber granules. This invention ensures production safety by regulating the amount of calcium oxide added, grinding power of the grinding device, temperature and speed of the compounding device, and exhaust system, to achieve the desired quality of the granules.

Notably, during the microwave grinding process of plant fibers, internal moisture is released, which affects subsequent preparation processes. Calcium oxide can absorb moisture, and adding calcium oxide during microwave grinding is beneficial for breaking hydrogen bonds between molecules in plant fibers. Therefore, when the relative content of hydrogen bonds in the plant fibers is less than or equal to the first preset level, it indicates that the released moisture from the plant fibers is low. In this case, the central control device determines to decrease the mass of added calcium oxide. Conversely, when the relative content of hydrogen bonds in the plant fibers is greater than or equal to the second preset level, it indicates that the released moisture from the plant fibers is high. In this case, the central control device determines to increase the mass of added calcium oxide to ensure sufficient moisture absorption. Additionally, calcium oxide can also act as an abrasive, and a higher proportion of plant fibers in the mixture indicates greater grinding difficulty. Thus, larger particle size of calcium oxide is selected by the central control device based on the proportion of plant fiber mass to achieve more effective grinding.

Indeed, when calcium oxide absorbs moisture, a portion of it may convert into calcium hydroxide, causing a change in the pH value of the first mixture. If the pH value of the first mixture obtained by the central control device after the first preset duration is lower than or equal to the preset pH value, it indicates that the grinding degree of the plant fibers is low and the release of internal moisture is limited. Therefore, the central control device determines to increase the microwave power of the grinding device in order to enhance the grinding process.

Indeed, during the compounding process, both the plant fibers and the matrix resin may absorb moisture, resulting in changes in the mass of the third mixture. When the obtained mass change is less than or equal to the preset mass change, it indicates that the absorbed moisture can be reacted by the calcium oxide and does not affect the quality of the masterbatch. However, when the obtained mass change is greater than the preset mass change, it indicates that excessive moisture has been absorbed. The central control device obtains the pH value change rate of the third mixture. When the obtained pH value change rate is less than or equal to the preset pH value change rate, it indicates that the amount of calcium oxide in the mixture is not sufficient to react with the absorbed moisture, which may result in issues such as the formation of bubbles in the masterbatch. In this case, the central control device determines to increase the mass of calcium oxide in the next preparation process. When the obtained pH value change rate is greater than the preset pH value change rate, it indicates that although calcium oxide absorbs moisture, the mixture absorbs too much moisture during the compounding process, and the pH value cannot be increased indefinitely. Therefore, the central control device determines to increase the temperature and speed of the compounding device in order to facilitate the rapid evaporation of moisture into water vapor and reduce the moisture absorption time.

### BRIEF DESCRIPTION OF DRAWINGS

FIG. 1 is a schematic diagram of the system for preparing the biodegradable plant fiber masterbatch according to one embodiment of the present invention.

FIG. 2 is a schematic diagram of the mixing mechanism according to one embodiment of the present invention.

FIG. 3 is a flow diagram of the method for preparing the biodegradable plant fiber masterbatch according to one embodiment of the present invention.

### DETAILED DESCRIPTION OF THE DISCLOSURE

In order to make the objects and advantages of the present invention clearer, the present invention will be further described below in conjunction with the examples; it should be understood that the specific examples described here are only for explaining the present invention, and are not intended to limit the present invention.

Preferred embodiments of the present invention are described below with reference to the accompanying drawings. Those skilled in the art should understand that these embodiments are only used to explain the technical principle of the present invention, and are not intended to limit the protection scope of the present invention.

It should be noted that, in the description of the present invention, terms such as “upper”, “lower”, “left”, “right”, “inner”, “outer” and other indicated directions or positional relationships are based on the terms shown in the accompanying drawings. The direction or positional relationship shown is only for convenience of description, and does not indicate or imply that the device or element must have a specific orientation, be constructed and operated in a specific orientation, and thus should not be construed as limiting the present invention.

In addition, it should be noted that, in the description of the present invention, unless otherwise clearly stipulated and limited, the terms “installation”, “connection” and “attach” should be understood in a broad sense, for example, it can be a fixed connection or a It is a detachable connection or an integral connection; it may be a mechanical connection or an electrical connection; it may be a direct connection or an indirect connection through an intermediary, and it may be the internal communication of two components. Those skilled in the art can understand the specific meanings of the above terms in the present invention according to specific situations.

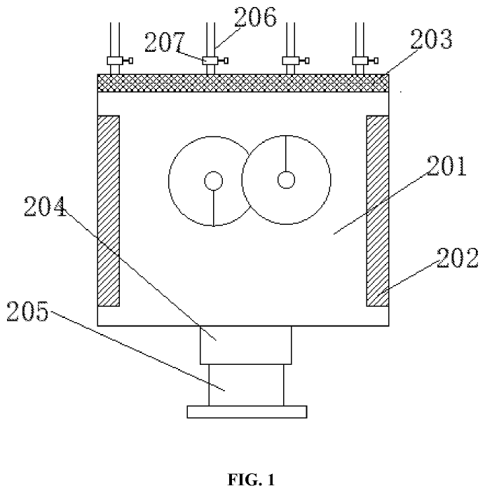

Please refer to FIG. 1, which depicts the schematic diagram of the system for preparing biodegradable plant fiber masterbatch according to one embodiment of the present invention. The system includes:
a grinding device, which is configured for micronizing a first mixture through microwave grinding and coherently coating the microwave-treated first mixture with a coupling agent to form a second mixture;
a compounding device, which is configured for compounding the second mixture with a compatibilizer and a matrix resin to form a third mixture. The compounding device includes a compounding vessel 201 for accommodating the third mixture, a rotating mechanism connected to the compounding vessel, heating pipes 202 arranged on both sides of the compounding vessel for heating, an exhaust system on the sealing cover 203 for ventilation, and a mixing mechanism inside the compounding vessel for stirring. The rotating mechanism comprises a rotating shaft 204 connected to the compounding vessel and a first motor 205 connected to the rotating shaft to provide power. The exhaust system includes several exhaust pipes 206 and exhaust valves 207 on the exhaust pipes for adjusting the opening;
a extrusion device, which is configured for extruding and pelletizing the compounded third mixture.

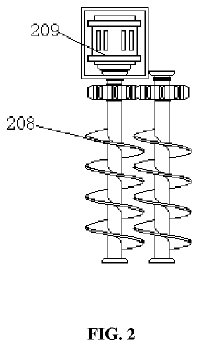

Please refer to FIG. 2, which illustrates the schematic diagram of the mixing mechanism according to one embodiment of the present invention. The system further includes:
the mixing mechanism, which is positioned inside the compounding vessel for stirring. The mixing mechanism includes mixing rolls 208 that come into contact with the third mixture, and a second motor 209 that provides power for the mixing rolls;
a central control device, which is connected to the grinding device, the compounding device, and the extrusion device. The central control device is configured for adjusting the mass of calcium oxide added based on the relative content of intermolecular hydrogen bonding of the selected plant fibers, and select the particle size of calcium oxide based on the mass proportion of plant fibers in the first mixture. The central control device adjusts the microwave power of the grinding device based on the pH value of the first mixture after a preset grinding time, and obtains the water absorption of the second mixture during the compounding process. When the water absorption obtained by the central control device does not meet the preset criteria, the central control device adjusts the temperature and rotation speed of the compounding device by controlling the thermal parameters of the heating pipes and the power parameters of the rotating mechanism, and monitors and adjusts the pressure inside the compounding vessel to ensure safety. When the water absorption obtained by the central control device meets the preset criteria, the extrusion device performs extrusion and pelletizing. The central control device obtains the shrinkage of the biodegradable plant fiber masterbatch formed after extrusion pelletizing, and adjusts the CO₂ concentration in the base device to meet the preset criteria.

Specifically, in this embodiment of the invention, appropriate microwave grinding and granulating equipment may be chosen as the grinding and extrusion apparatus, depending on the actual circumstances.

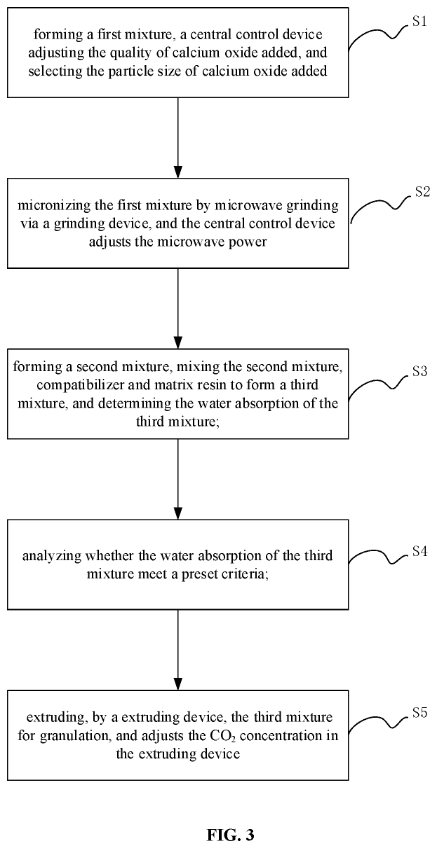

Please refer to FIG. 3, which depicts the process flowchart for the preparation of biodegradable plant fiber masterbatch according to an embodiment of the present invention. The method comprises the following steps:
Step S1, adding calcium oxide into plant fiber to form a first mixture; wherein a central control device is configured to modulate a mass of the calcium oxide based on a relative content of intermolecular hydrogen bonding in the plant fiber, and determine particle size of the calcium oxide based on a proportionate mass of the plant fiber in the first mixture.
Step S2, micronizing the first mixture by microwave grinding using a grinding device; the central control device is configured to acquire a pH value of the first mixture after microwave grinding for a preset duration, and then compare the acquired pH value with a preset pH value for adjusting a microwave power of the grinding device.
Step S3, adding a coupling agent to the first mixture that has been microwave-treated, to achieve co-blending and coating, resulting in the formation of a second mixture; the second mixture, along with a compatibilizer and a matrix resin, are mixed to form a third mixture; the third mixture is then subjected to compounding in a compounding device; the central control device is configured to acquire a mass change of the third mixture after compounding for a second preset duration, and determine a moisture absorption of the third mixture based on the mass change.
Step S4, acquiring, by the central control device, a pH change rate of the third mixture after the second preset duration when the central control device determines that the moisture absorption of the third mixture does not meet a preset criteria; if the pH change rate exceeds the preset criteria, adjusting a temperature and rotational speed of the compounding device; wherein, the central control device acquires a real-time pressure in the compounding device and adjusts an exhaust system of the compounding device when the acquired pressure does not meet the preset criteria, for bring the pressure in the compounding device to meet the preset criteria; if the pH change rate obtained by the central control device is lower than the preset criteria, the mass of calcium oxide in the first mixture is adjusted to ensure that the subsequent biodegradable plant fiber masterbatch meet the preset criteria.
Step S5, when the central control device determines that the moisture absorption of the third mixture meets the preset criteria, extruding, by an extrusion device, the third mixture into pellets, forming biodegradable plant fiber masterbatch; the central control device is configured to acquire a shrinkage of the biodegradable plant fiber masterbatch based on a volume change, and compare the shrinkage with a preset shrinkage criteria; the central control device is further configured to adjust a CO₂ concentration in the extrusion device to ensure that the biodegradable plant fiber masterbatch meet the preset shrinkage criteria.

Furthermore, in Step S1, the central control device is configured to obtain the relative content p of intermolecular hydrogen bonds in the plant fiber, and compare the relative content of hydrogen bonds with the preset relative content P of hydrogen bonds; the central control device then is configured to adjust the mass of the calcium oxide; wherein:
when p≤P1, the central control device determines to decrease the mass of the calcium oxide from m to m1, where m1=m×(1−|P1−p|/P1);
when P1<p<P2, the central control device does not adjust the mass of the calcium oxide;
when p≥P2, the central control device determines to increase the mass of the calcium oxide from m to m2, where m2=m×(1+|P2−p|/P2);
wherein the central control device presets the preset hydrogen bond relative content P; wherein the first preset hydrogen bond relative content is set as P1, and the second preset hydrogen bond relative content P2.

Furthermore, the central control device is configured to acquire a mass proportion d of the plant fiber in the first mixture, wherein d is defined as q1/q, with q being the mass of the first mixture and q1 being the mass of the plant fiber in the first mixture; the central control device is configured to compare the mass proportion with a preset mass proportion D, and determine particle size of the calcium oxide to be added; wherein:
when d≤D1, the central control device determines the calcium oxide with a first preset particle size R1 for addition;
when D1<d<D2, the central control device determines the calcium oxide with the second preset particle size R2 for addition;
when d≥D2, the central control device determines the calcium oxide with the third preset particle size R3 for addition;
wherein the central control device sets the preset mass proportion as D and the preset particle size as R; wherein the first preset mass proportion is D1, the second preset mass proportion is D2; the first, second, and third preset particle sizes are R1, R2, and R3, respectively.

Specifically, during the process of microwave grinding, plant fibers release internal moisture which can affect subsequent preparation processes. Calcium oxide can absorb moisture and adding it during microwave grinding can facilitate the disruption of hydrogen bonds between the plant fibers. Therefore, when the relative content of hydrogen bonds in plant fibers is equal to or less than the first preset relative content, it indicates that the released moisture from the plant fibers is minimal. In this case, the control device determines to reduce the quantity of calcium oxide added. On the other hand, when the relative content of hydrogen bonds in plant fibers is equal to or greater than the second preset relative content, it indicates that the released moisture from the plant fibers is significant. In this case, the control device determines to increase the quantity of calcium oxide added to fully absorb the moisture. Additionally, calcium oxide also acts as an abrasive, and as the proportion of plant fibers in the mixture increases, indicating higher grinding difficulty, larger particle size of calcium oxide is needed to ensure thorough grinding of the plant fibers. The control device selects different particle sizes of calcium oxide based on the proportion of plant fiber quality.

Specifically, different plant fibers have different relative amounts of intermolecular hydrogen bonds. For example, the molecular hydrogen bond relative content in eucalyptus pulp fibers is 48.15%.

In step S2, the central control device sets a preset pH value K; the central control device is configured to compare a pH value k of the first mixture, which has been micronizing for the first preset duration, with the preset pH value; the central control device then is configured to adjust the microwave power of the grinding device; wherein:
when k≤K, the central control device increases the microwave power of the grinding device;
when k>K, the central control device does not adjust the microwave power of the grinding device.

Specifically, when calcium oxide absorbs moisture, a portion of it will convert into calcium hydroxide, causing a change in the pH value of the first mixture. If the pH value of the first mixture obtained by the central control device after the first preset duration is lower than or equal to the preset pH value, it indicates that the grinding degree of the plant fibers is low and the moisture release is insufficient. Therefore, the central control device determines to increase the microwave power of the grinding device.

In step S3, the central control device is configured to acquire a mass change Δg of the third mixture after the second preset duration, and compare the mass change Δg with a preset mass change ΔG to determine the water absorption condition of the third mixture; wherein:
when Δg≤ΔG, the central control device determines that the water absorption condition of the third mixture meets the preset criteria;
when Δg>ΔG, the central control device determines that the water absorption condition of the third mixture does not meet the preset criteria, and obtains the pH change rate of the third mixture.

In step S4, when the central control device determines that the water absorption of the third mixture does not meet the preset criteria, the central control device is configured to obtain the pH change rate Δk of the third mixture, where Δk is set as |k2−k1|, with k1 being the pH value of the third mixture obtained by the central control device at the beginning of the second preset duration, and k2 being the pH value of the third mixture obtained by the central control device at the end of the second preset duration; the central control device is configured to compare the obtained pH change rate with the preset pH change rate ΔK to analyze the reason for the non-compliance of the water absorption of the third mixture with the preset criteria; wherein:
when Δk≤ΔK, the central control device determines that the quality of the calcium oxide in the first mixture does not meet the preset criteria, and increases the mass of the calcium oxide in the first mixture to ensure that the subsequent plant fiber masterbatch meet the preset criteria;
when Δk>ΔK, the central control device determines that the temperature and speed of the mixing device do not meet the preset criteria.

Furthermore, when the central control device obtains the pH change rate of the third mixture that is greater than the preset pH change rate, the central control device is configured to compare the obtained pH change rate Δk with a standard value ΔK0 of the preset pH change rate criteria, and adjust the temperature and rotational speed of the compounding device.
when Δk≤ΔK0, the central control device determines to increase the temperature of the compounding device and increase the rotational speed of the compounding device;
when Δk>ΔK0, the central control device determines to increase the temperature of the compounding device.

Specifically, during the compounding process, both the plant fibers and the matrix resin tend to imbibe moisture, resulting in changes in the mass of the tertiary mixture. When the observed mass change is less than or equal to the preset mass change, it signifies that the absorbed moisture can be reacted with calcium oxide, without adversely affecting the quality of the parent granules. However, when the observed mass change exceeds the preset mass change, it indicates excessive moisture absorption. The central control device monitors the pH change rate in the tertiary mixture, and when the observed pH change rate is less than or equal to the preset pH change rate, it suggests that the calcium oxide content in the mixture may be insufficient to react with the absorbed moisture, potentially leading to issues such as air bubbles in the parent granules. In such cases, the central control device determines to increase the quantity of calcium oxide in the subsequent preparation process. On the other hand, when the observed pH change rate is greater than the preset pH change rate, it implies that although calcium oxide is absorbing moisture, the tertiary mixture is still taking in excessive moisture during the compounding process, causing the pH value to increase uncontrollably. Hence, the central control device determines to elevate the temperature and rotational speed of the compounding equipment, allowing for rapid evaporation of moisture into water vapor and reducing the moisture absorption time.

When the central control device increases the temperature of the compounding device, the central control device sets a preset pressure value F and compares the real-time pressure value f obtained from the compounding device with the preset pressure value; the central control device determines the activation of the exhaust system and adjusts the opening of an exhaust valve in the exhaust system.

When f≤F1, the central control device does not activate the exhaust system.

When F1<f<F2, the central control device activates the exhaust system with the opening of the exhaust valve set to a preset value.

When f≥F2, the central control device activates the exhaust system and increases the opening of the exhaust valve from n to n′, where n′=n×(1+|F2−f1|F2/2).

The central control device sets the preset pressure value F and defines the first preset pressure value F1 and the second preset pressure value F2.

In particular, when the central control device raises the temperature of the compounding equipment, the pressure inside the compounding equipment increases. Under high temperature and high pressure conditions, there is a risk of explosion. To eliminate this safety hazard, it is necessary to monitor the pressure inside the compounding equipment. Therefore, the central control device obtains real-time pressure data from the compounding equipment and compares it with the preset pressure levels. If the real-time pressure exceeds the first preset pressure level, it indicates that the pressure is too high and there is a risk of explosion. In such cases, the central control device activates the exhaust system. When the real-time pressure obtained by the central control device is greater than the first preset pressure level but less than the second preset pressure level, the exhaust valve in the exhaust system is maintained at the preset opening to meet the requirements. However, when the real-time pressure obtained by the central control device is equal to or greater than the second preset pressure level, it indicates that the pressure inside the compounding equipment is excessively high, and the opening of the exhaust valve needs to be increased to rapidly reduce the pressure inside the compounding equipment. Therefore, the central control device determines to increase the opening of the exhaust valve.

The central control device sets a preset criteria value N for the opening of the exhaust valve, and compares the obtained exhaust valve opening with the preset criteria value; the central control device is configured to adjust the number of activated exhaust valves.

When n′≤N, the central control device does not adjust the number of activated exhaust valves.

When n′>N, the central control device determines to increase the number of activated exhaust valves from z to z1, where

$$z 1 = z \times ( 1 + \sqrt{\frac{\vert N - {n}^{′} \vert}{N}} ) .$$

Specifically, the central control device compares the opening degree of the exhaust valve with the preset exhaust valve opening criteria value, and adjusts the number of exhaust valves to be started. When the opening degree of the exhaust valve obtained by the central control device is greater than the preset exhaust valve opening criteria value, it may allow external gas to enter the mixing device, affecting the mixing process. Therefore, the central control device determines to increase the number of started exhaust valves, so that the opening degree of the exhaust valves complies with the preset criteria, while maintaining the air pressure of the mixing device within the preset criteria.

The central control device obtains the shrinkage degree s of the masterbatch, where s is set as s=s2−s1; where, s1 represents a volume of the masterbatch during extrusion, and s2 represents a volume of the masterbatch after the third preset duration; the central control device compares the obtained shrinkage degree with the preset shrinkage degree S, and adjusts the CO₂ concentration in the extrusion device.

When s≤S1, the central control device determines to decrease the CO₂ concentration in the extrusion device from w to w1, where

$$w 1 = w \times ( 1 - \sqrt{\frac{s}{S 1}} ) .$$

When S1<s<S2, the central control device determines not to adjust the CO₂ concentration in the extrusion device.

When s≥S2, the central control device determines to increase the CO₂ concentration in the extrusion device from w to w2, where

$$w 2 = w \times ( 1 + \sqrt{\frac{s}{S 2}} ) .$$

The central control device sets the preset shrinkage degree S, and defines the first preset shrinkage degree as S1 and the second preset shrinkage degree as S2.

Specifically, in the aforementioned extrusion device, the reaction between calcium hydroxide and CO₂ yields calcium carbonate, which acts as a nucleating agent to mitigate the shrinkage of the prepared granules. However, an excessive content of calcium carbonate may impact the performance of the granules. Hence, when the central control device detects a shrinkage equal to or smaller than the first preset shrinkage, it indicates that the granules exhibit lesser shrinkage and hence a higher content of calcium carbonate. As a result, the central control device reduces the CO₂ concentration in the extrusion device. Conversely, when the central control device detects a shrinkage equal to or greater than the second preset shrinkage, it indicates that the granules exhibit greater shrinkage and hence a lower content of calcium carbonate. Consequently, the central control device increases the CO₂ concentration in the extrusion device.

Specifically, the present invention does not limit the preparation method of bio-based hot-melt adhesive for improving adhesive strength. An exemplary embodiment of the present invention provides a preferred implementation plan, wherein the mass ratio of plant fibers to calcium oxide is set between 50:1 to 7. When 30 kg of Eucalyptus pulp fibers are used, the mass of calcium oxide added is 3 kg. The relative content of the first preset hydrogen bonds is 30%, and the relative content of the second preset hydrogen bonds is 70%. The relative content of hydrogen bonds in Eucalyptus pulp fibers is 48.15%. Therefore, the central control device determines that no adjustment is needed for the mass of calcium oxide. The central control device compares the mass proportion of Eucalyptus pulp fibers in the first mixture, which is 91%, with the first preset mass proportion of 75% and the second preset mass proportion of 95%, and determines to select calcium oxide with a particle size of 250-300 mesh as the second particle size, with the first particle size being 200-250 mesh, and the third particle size being 300-350 mesh. After microwave grinding for 1 minute according to the first preset duration, the pH value of the first mixture is compared with the preset pH value of 11.8, and the microwave power of the grinding device is adjusted. Silane coupling agent is added to the first mixture at a mass of 0.05 kg for co-blending and coating to form the second mixture. Then, 13.5 kg of polybutylene succinate and 53 kg of polylactic acid are added for compounding. After the second preset duration of 3 minutes, the central control device compares the mass change of 0.3 kg obtained with the preset mass change of 0.2 kg, determines that the water absorption condition does not meet the preset criteria, and obtains the pH value change rate of the third mixture, which is greater than the preset pH value change rate of 0.7 but less than or equal to the criteria pH value change rate of 0.9. The central control device determines to adjust the temperature and speed of the compounding device, and after heating, the central control device obtains the real-time pressure inside the compounding device, which is greater than or equal to the first preset pressure of 220 kPa but less than the second preset pressure of 260 kPa. The central control device starts the exhaust system, with the opening of the exhaust valve set at 30% and a total of 4 exhaust valves being opened. After completion of compounding, the third mixture is fed into the extrusion device for palletizations. The central control device obtains the shrinkage degree of the biodegradable pellets of plant fibers after the third preset duration of 20 minutes, and compares the obtained shrinkage degree with the first preset shrinkage degree of 0.2 and the second preset shrinkage degree of 0.5, without adjusting the CO₂ concentration of the extrusion device, which is set at 0.04%.

What is claimed is:

1. A method for preparing biodegradable plant fiber masterbatch, comprising:
Step S1, adding calcium oxide into plant fiber to form a first mixture; wherein a central control device is configured to modulate a mass of the calcium oxide based on a relative content of intermolecular hydrogen bonding in the plant fiber, and determine particle size of the calcium oxide based on a proportionate mass of the plant fiber in the first mixture;
Step S2, micronizing the first mixture by microwave grinding using a grinding device; the central control device is configured to acquire a pH value of the first mixture after microwave grinding for a preset duration, and then compare the acquired pH value with a preset pH value for adjusting a microwave power of the grinding device;
Step S3, adding a coupling agent to the first mixture that has been microwave-treated, to achieve co-blending and coating, resulting in the formation of a second mixture; the second mixture, along with a compatibilizer and a matrix resin, are mixed to form a third mixture; the third mixture is then subjected to compounding in a compounding device; the central control device is configured to acquire a mass change of the third mixture after compounding for a second preset duration, and determine a moisture absorption of the third mixture based on the mass change;
Step S4, acquiring, by the central control device, a pH change rate of the third mixture after the second preset duration when the central control device determines that the moisture absorption of the third mixture does not meet a preset criteria; if the pH change rate exceeds the preset criteria, adjusting a temperature and rotational speed of the compounding device; wherein, the central control device acquires a real-time pressure in the compounding device and adjusts an exhaust system of the compounding device when the acquired pressure does not meet the preset criteria, for bring the pressure in the compounding device to meet the preset criteria; if the pH change rate obtained by the central control device is lower than the preset criteria, the mass of calcium oxide in the first mixture is adjusted to ensure that the subsequent biodegradable plant fiber masterbatch meet the preset criteria; and
Step S5, when the central control device determines that the moisture absorption of the third mixture meets the preset criteria, extruding, by an extrusion device, the third mixture into pellets, forming biodegradable plant fiber masterbatch; the central control device is configured to acquire a shrinkage of the biodegradable plant fiber masterbatch based on a volume change, and compare the shrinkage with a preset shrinkage criteria; the central control device is further configured to adjust a CO₂ concentration in the extrusion device to ensure that the biodegradable plant fiber masterbatch meet the preset shrinkage criteria.

2. The method according to claim 1, wherein, in Step S1, the central control device is configured to obtain the relative content p of intermolecular hydrogen bonds in the plant fiber, and compare the relative content of hydrogen bonds with the preset relative content P of hydrogen bonds; the central control device then is configured to adjust the mass of the calcium oxide; wherein:
when p≤P1, the central control device determines to decrease the mass of the calcium oxide from m to m1, where m1=m×(1−|P1−p|/P1);
when P1<p<P2, the central control device does not adjust the mass of the calcium oxide;
when p≥P2, the central control device determines to increase the mass of the calcium oxide from m to m2, where m2=m×(1+|P2−p|/P2);
wherein the central control device presets the preset hydrogen bond relative content P;
wherein the first preset hydrogen bond relative content is set as P1, and the second preset hydrogen bond relative content P2.

3. The method according to claim 2, wherein the central control device is configured to acquire a mass proportion d of the plant fiber in the first mixture, wherein d is defined as q1/q, with q being the mass of the first mixture and q1 being the mass of the plant fiber in the first mixture; the central control device is configured to compare the mass proportion with a preset mass proportion D, and determine particle size of the calcium oxide to be added; wherein:
when d≤D1, the central control device determines the calcium oxide with a first preset particle size R1 for addition;
when D1<d<D2, the central control device determines the calcium oxide with the second preset particle size R2 for addition;
when d≥D2, the central control device determines the calcium oxide with the third preset particle size R3 for addition;
wherein the central control device sets the preset mass proportion as D and the preset particle size as R; wherein the first preset mass proportion is D1, the second preset mass proportion is D2;
the first, second, and third preset particle sizes are R1, R2, and R3, respectively.

4. The method according to claim 3, wherein in step S2, the central control device sets a preset pH value K; the central control device is configured to compare a pH value k of the first mixture, which has been micronizing for the first preset duration, with the preset pH value; the central control device then is configured to adjust the microwave power of the grinding device; wherein:
when k≤K, the central control device increases the microwave power of the grinding device;
when k>K, the central control device does not adjust the microwave power of the grinding device.

5. The method according to claim 4, wherein, in step S3, the central control device is configured to acquire a mass change Δg of the third mixture after the second preset duration, and compare the mass change Δg with a preset mass change ΔG to determine the water absorption condition of the third mixture; wherein:
when Δg≤ΔG, the central control device determines that the water absorption condition of the third mixture meets the preset criteria;
when Δg>ΔG, the central control device determines that the water absorption condition of the third mixture does not meet the preset criteria, and obtains the pH change rate of the third mixture.

6. The method according to claim 5, wherein in step S4, when the central control device determines that the water absorption of the third mixture does not meet the preset criteria, the central control device is configured to obtain the pH change rate Δk of the third mixture, where Δk is set as |k2−k1|, with k1 being the pH value of the third mixture obtained by the central control device at the beginning of the second preset duration, and k2 being the pH value of the third mixture obtained by the central control device at the end of the second preset duration; the central control device is configured to compare the obtained pH change rate with the preset pH change rate ΔK to analyze the reason for the non-compliance of the water absorption of the third mixture with the preset criteria; wherein:
when Δk≤ΔK, the central control device determines that the quality of the calcium oxide in the first mixture does not meet the preset criteria, and increases the mass of the calcium oxide in the first mixture to ensure that the subsequent plant fiber masterbatch meet the preset criteria;
when Δk>ΔK, the central control device determines that the temperature and speed of the mixing device do not meet the preset criteria.

7. The method according to claim 6, wherein when the central control device obtains the pH change rate of the third mixture that is greater than the preset pH change rate, the central control device is configured to compare the obtained pH change rate of change Δk with a standard value ΔK0 of the preset pH change rate criteria, and adjust the temperature and rotational speed of the compounding device; wherein
when Δk≤ΔK0, the central control device determines to increase the temperature of the compounding device and increase the rotational speed of the compounding device;
when Δk>ΔK0, the central control device determines to increase the temperature of the compounding device.

8. The method according to claim 7, wherein when the central control device increases the temperature of the compounding device, the central control device sets a preset pressure value F and compares the real-time pressure value f obtained from the compounding device with the preset pressure value; the central control device determines the activation of the exhaust system and adjusts the opening of an exhaust valve in the exhaust system; wherein:
when f≤F1, the central control device does not activate the exhaust system;
when F1<f<F2, the central control device activates the exhaust system with the opening of the exhaust valve set to a preset value;
when f≥F2, the central control device activates the exhaust system and increases the opening of the exhaust valve from n to n′, where n′=n×(1+|F2−f|/F2/2);
wherein the central control device sets the preset pressure value F and defines the first preset pressure value F1 and the second preset pressure value F2.

9. The method according to claim 8, wherein the central control device sets a preset criteria value N for the opening of the exhaust valve, and compares the obtained exhaust valve opening with the preset criteria value; the central control device is configured to adjust the number of activated exhaust valves; wherein:
when n′≤N, the central control device does not adjust the number of activated exhaust valves;
when n′>N, the central control device determines to increase the number of activated exhaust valves from z to z1, where
$$z 1 = z \times ( 1 + \sqrt{\frac{\vert N - {n}^{′} \vert}{N}} ) .$$

10. The method according to claim 9, wherein the central control device obtains the shrinkage degree s of the masterbatch, where s is set as s=s2−s1; where, s1 represents a volume of the masterbatch during extrusion, and s2 represents a volume of the masterbatch after the third preset duration; the central control device compares the obtained shrinkage degree with the preset shrinkage degree S, and adjusts the CO₂ concentration in the extrusion device; wherein:
when s≤S1, the central control device determines to decrease the CO₂ concentration in the extrusion device from w to w1, where
$$w 1 = w \times ( 1 - \sqrt{\frac{s}{S 1}} ) ;$$
when S1<s<S2, the central control device determines not to adjust the CO₂ concentration in the extrusion device;
when s≥S2, the central control device determines to increase the CO₂ concentration in the extrusion device from w to w2, where
$$w 2 = w \times ( 1 + \sqrt{\frac{s}{S 2}} ) ;$$
wherein the central control device sets the preset shrinkage degree S, and defines the first preset shrinkage degree as S1 and the second preset shrinkage degree as S2.
